(19) United States
(12) Patent Application Publication
(10) Pub. No.: US 2002/0176718 A1
(43) Pub. Date: Nov. 28, 2002

(54) Image forming apparatus and image forming method

(75) Inventor: Hiromichi Mitamura, Tagata-gun (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/143,905

(22) Filed: May 14, 2002

(30) Foreign Application Priority Data
May 22, 2001 (JP) 2001-152703

(51) Int. Cl. G03G 15/06

(52) U.S. Cl. 399/55

(57) ABSTRACT

Toner which is made adjacent to a surface of a photosensitive body by a toner carrier is charged, by charge injection from the toner carrier, to have the same polarity as that of a third potential a potential of the toner carrier. A first potential which is a potential of a base material of the photosensitive body, a second potential which is an apparent potential of the photosensitive body, and the third potential of the toner carrier are set such that in the absolute values, first potential>third potential>second potential. As a result, the relation exposed part potential>toner carrier potential>non-exposed part potential, is established. Therefore, the toner is selectively adsorbed only to non-exposed parts.

### CROSS-REFERENCE TO RELATED APPLICATIONS

This application is based upon and claims the benefit of priority from the prior Japanese Patent Application No. 2001-152703, filed May 22, 2001, the entire contents of which are incorporated herein by reference.

### BACKGROUND OF THE INVENTION

1. Field of the Invention

The present invention relates to an image forming apparatus and image forming method, which perform image formation by an electrophotograph process.

2. Description of the Related Art

A normal development system and a reversal development system are known as development systems in an electrophotograph process.

In a normal development system, an exposed part potential and non-exposed part potential in a surface potential of a photosensitive body and developing bias potential have a relation as shown in FIG. 7. Specifically, toner charged to have polarity opposite to that of the non-exposed part potential is electrostatically adsorbed to the non-exposed parts.

In a reversal development system, an exposed part potential and non-exposed part potential in the surface potential of a photosensitive body and developing bias potential have a relation as shown in FIG. 8. Specifically, toner charged to have the same polarity as that of the non-exposed part potential is electrostatically adsorbed to the exposed parts.

When these two systems are compared, the normal development system can form an image having a better image quality, since it can minutely reproduce fine lines and clearly reproduce black color.

In the case of adopting normal development system, toner is required to be charged to have polarity opposite to the charging polarity of the photosensitive body. Further, the developing bias has polarity opposite to the charging polarity of the toner. Specifically, as shown in FIG. 7, the developing bias is 150 V, and the charging polarity of the toner is negative. Therefore, the developing bias causes charge injection into the toner, which may cause lowering of the charging potential of the toner and inversion of the charging polarity of the toner. Further, the toner with the lowered charging potential is hard to be adsorbed to the non-exposed parts, which causes lowering of the image density. Further, toner grain A, whose charging polarity has been inversed, is adsorbed to the exposed part, as shown in FIG. 7. It causes adhesion of the toner to the photosensitive body, that is, it causes black spots on background.

Therefore, in the case of adopting the normal development system, it is necessary to use toner which does not readily cause charging due to charge injection. Therefore, in the case of adopting the normal development system, toner into which carriers and charging members are mixed so that triboelectrification is sufficiently performed is generally used.

Further, the mixing ratio of carriers to toner is set to a high ratio to perform sufficient triboelectrification.

However, in the case of using such toner, the image quality deteriorates with deterioration of the carriers and charging members, and it is difficult to make a long-life developing device.

### BRIEF SUMMARY OF THE INVENTION

The object of the present invention is to provide an image forming apparatus and image forming method which can form an image having a good image quality by normal development system, while using toner being apt to be charged due to charge injection.

According to an aspect of the present invention, toner which is made adjacent to the surface of the photosensitive body by toner carriers is charged to have the same polarity with that of a third potential by charge injection from the toner carriers. With respect to the toner charged like this, a relation: in the absolute values, first potential>third potential>second potential is established, that is, a relation: exposed part potential>toner carrier potential>non-exposed part potential is established. Therefore, toner is selectively adsorbed only to non-exposed parts.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed our hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing a structure of a main part of an image forming apparatus according to an embodiment of the present invention.

FIG. 2 is a diagram showing a detailed structure of a part of the structure of FIG. 1 and a main part of an electric structure of FIG. 1.

FIG. 3 is a diagram showing a principle of development by a developing device 4 in FIG. 1.

FIG. 4 is a diagram showing a detailed structure of a part of the structure of FIG. 1 and a modification of the main part of the electric structure of FIG. 1.

FIG. 5 is a diagram showing a principle of development by the developing device 4 in FIG. 1.

FIG. 6 is a diagram showing a modification of the charging device.

FIG. 7 is a drawing showing a principle of development by a conventional normal development system.

FIG. 8 is a drawing showing a principle of development by a conventional reversal development system.

### DETAILED DESCRIPTION OF THE INVENTION

An embodiment of the present invention will now be described with reference to the drawings.

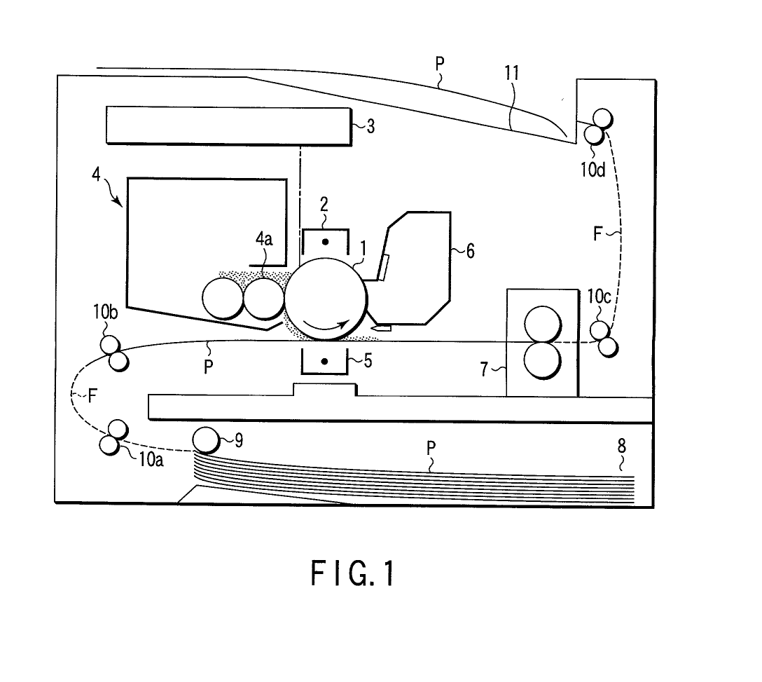

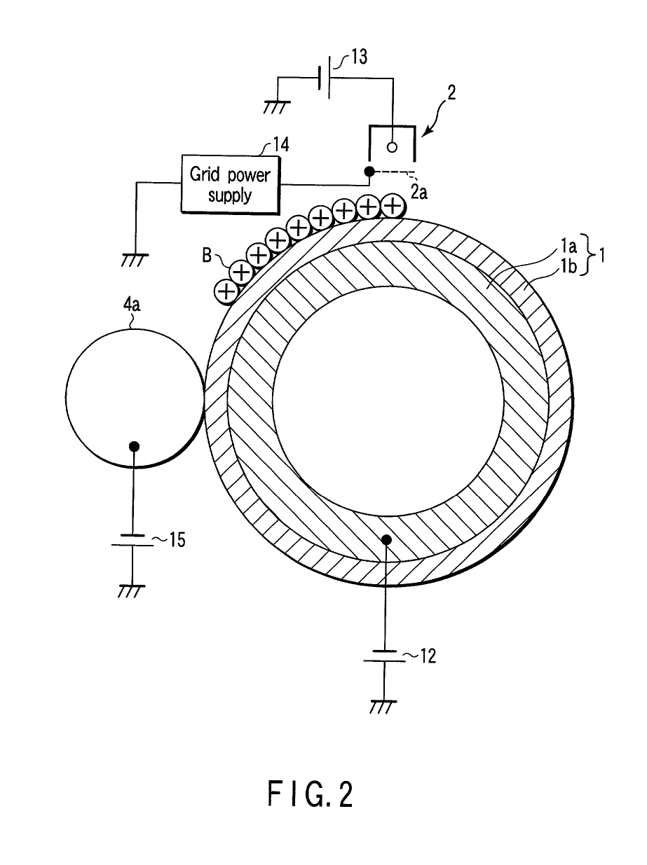

FIG. 1 is a diagram showing a structure of a main part of an image forming apparatus according to the embodiment. FIG. 2 is a diagram showing detailed structure of a part of the structure of FIG. 1 and a main part of an electric structure of FIG. 1.

As shown in these drawings, the image forming apparatus of the embodiment comprises a photosensitive body 1, charging device 2, exposure device 3, developing device 4, transfer device 5, cleaning unit 6, fixing device 7, paper storing section 8, pick-up roller 9, conveying rollers 10a, 10b, 10c and 10d, delivery tray 11, drum bias power supply 12, charging power supply 13, grid power supply 14 and developing bias power supply 15.

The photosensitive body 1 has a structure wherein a photosensitive layer 1b is formed by applying a photosensitive conductive material on a surface of a base material 1a made of a cylindrical conductive body such as aluminum. FIG. 2 shows a cross section of the detailed structure of the photosensitive body 1. The photosensitive body 1 is rotated at a fixed speed by a rotation force of a motor (not shown) in the direction indicated by an arrow in FIG. 1.

Around the photosensitive body 1, the charging device 2, exposure device 3, developing device 4, transfer device 5 and cleaning unit 6 are arranged along the outer peripheral surface of the photosensitive body 1.

The charging device 2 uniformly charges the surface of the photosensitive body 1 to a predetermined potential. Specifically, the charging device 2 functions as charging means. In the embodiment, the charging device 2 is of a scorotron type having a grid 2a as shown in FIG. 2.

As the exposure device 3, a well-known laser beam scanner or LED head, etc. is used. The exposure device 3 performs exposure of the photosensitive surface of the photosensitive body 1 according to print data to form an electrostatic latent image on the photosensitive surface of the photosensitive body 1. Specifically, the exposure device 3 functions as exposure means.

The developing device 4 has a developing roller 4a as a toner carrier. By the developing roller 4a, toner is adhered to the surface of the photosensitive body 1 on which the electrostatic latent image has been formed. As a result, development is performed by electrostatic toner adsorption on the photosensitive body 1, and a toner image is formed on the photosensitive body 1. Specifically, the developing device 4 functions as developing means.

The transfer device 5 transfers the toner image formed on the photosensitive body 1 onto recording paper P inserted between the photosensitive drum 1 and the transfer device 5.

The cleaning unit 6 removes toner remaining on the surface of the photosensitive drum 1, not being transferred onto the recording paper P.

A heat roller, for example, is used as the fixing device 7. The fixing device 7 melts and fixes the toner image transferred onto the recording paper P on the recording paper P.

The paper storing section 8 stores recording paper P, onto which images are recorded.

The pick-up roller 9 is rotated by a motor (not shown). As a result, recording paper P stored in the paper storing section 8 is picked up sheet by sheet, and carried out to a conveying path F formed by a conveying guide (not shown), etc. The recording paper p carried out to the conveying path F is conveyed along the conveying path F by the conveying rollers 10a, 10b, 10c and 10d rotated by motors (not shown).

Printed recording paper P is placed on the delivery tray 11.

The drum bias power supply 12 applies a drum bias to the photosensitive body such that the potential of the base material 1a (hereinafter refers to as “drum bias potential) of the photosensitive body 1 becomes a first potential V1 having a negative polarity. The drum bias power supply 12 functions as first power supply means. The drum bias potential is set to −750 V in the embodiment.

The charging power supply 13 generates a high voltage of positive polarity for causing the charging device 2 to discharge electricity, and applies the voltage to the charging device 2.

The grid power supply 14 generates a grid voltage to be applied to the grid 2a. The grid power supply 14 can vary the potential of the grid 2a (hereinafter referred to as “grid control potential”) to a second potential V2 which has a predetermined range around 0V (earth). However, if the polarity of the grid control potential is the same as that of the drum bias potential (the first potential V1), the range of the grid voltage of the grid power source 14 is a range in which the absolute value of the grid control potential (the second potential V2) is smaller than the absolute value of a developing bias potential (a third potential V3).

The developing bias power supply 15 applies to the developing roller 4a of the developing device 4 a developing bias which makes the potential of the developing roller 4a (hereinafter referred to as “developing bias potential”) the third voltage V3. The developing bias power supply 15 functions as second power supply means. Further, the developing bias potential is set to −600 V in the embodiment.

Next, operation of the image forming apparatus structured as described above will now be described.

First, since the charging device 2 is of a scorotron type, the surface of the photosensitive body 1 is charged by the charging device 2 such that the apparent potential of the photosensitive body 1 conforms to the grid control potential (the second potential V2). Specifically, supposing the grid control potential (the second potential V2) is set to 0 V, a positive-pole charge B is applied onto the surface of the photosensitive body 1 such that it balances the drum bias potential (the first potential V1) −750 V and the apparent potential of the photosensitive body 1 is 0 V.

As described above, in the embodiment, the apparent potential of the photosensitive body 1 conforms to the grid control potential (the second potential V2).

In the surface of the photosensitive drum, which has been uniformly charged such that its apparent potential is 0 V, areas which does not form a toner image, that is, areas in which a ground color of the recording paper P is left intact are selectively subjected to exposure. Thereby, in the exposed areas (hereinafter referred to as “exposed parts”), charge generated in the photosensitive layer 1b by exposure neutralizes the positive charge which has been applied onto the surface of the photosensitive body 1. Consequently, the apparent potential of the exposed parts becomes the drum bias potential (the first potential V1). In contrast with this, the apparent potential of non-exposed areas (hereinafter referred to as “non-exposed parts”) remains 0 V.

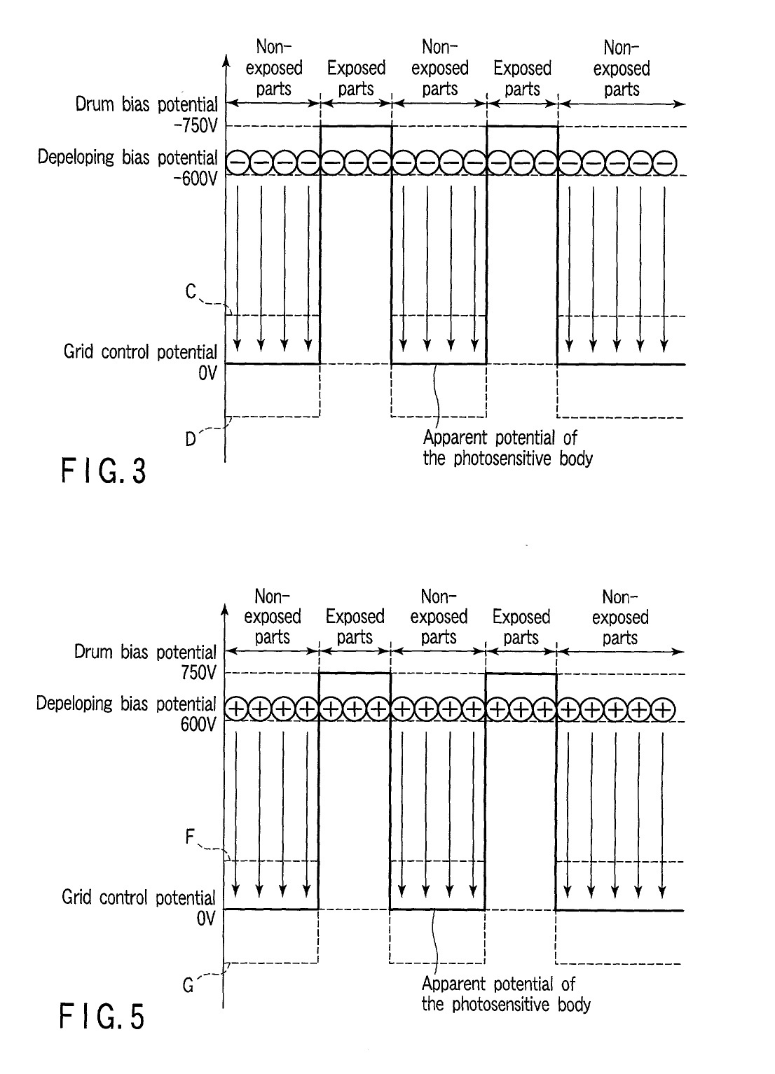

Next, after the photosensitive body 1 has passed a position of exposure by the exposure device 3, the apparent potential of the photosensitive body 1 is in the state as shown in FIG. 3.

In the meantime, in the developing device 4, toner is carried and conveyed by the developing roller 4a. In this step, the toner is charged to have negative polarity by negative charge injected from the developing roller 4a. Further, the toner charged to have negative polarity as described above is adhered onto the surface of the photosensitive body 1.

At this time, as is clear from FIG. 3, the apparent potential of each of the non-exposed parts of the photosensitive body 1 becomes higher than the developing bias potential (the third potential V3), for the toner. Therefore, the toner in the non-exposed parts is electrostatically adhered onto the surface of the photosensitive body 1. However, the apparent potential of the exposed parts of the photosensitive body 1 is lower than the developing bias potential (the third potential V3), for the toner. Thereby, the toner electrostatically repels the surface of the photosensitive body 1. Therefore, in the exposed parts, the toner does not adhere onto the surface of the photosensitive body 1.

As described above, the toner selectively adheres only to the non-exposed parts of the photosensitive body 1, and a desired toner image is formed on the surface of the photosensitive body 1.

As described above, according to the embodiment, it is possible to charge toner by charge injection, while development by a normal development system is performed. Specifically, since the toner has the same polarity as that of the developing bias potential (the third potential V3), the charging characteristic of the toner does not change, even if the toner is charged by charge injection.

As described above, since it is possible to use toner into which no carriers and charging member are mixed, it is possible to perform stable image formation over a long term. Further, it is possible to achieve good image quality with little black spots on background due to reversal of the charging polarity of the toner.

Further, since the toner can be charged by charge injection, even in the case where toner into which carriers and charging member are mixed is used, it is possible to reduce the mixing ratio of carriers and charging member to the toner in comparison with the conventional art. Therefore, more toner for the reduced amount of carriers and charging member can be stored in the toner storing section, which can contributes to achieving of long life (using for a long term) of the developing device and reduction of the number of times of toner supply.

Further, according to the embodiment, since the drum bias potential (the first potential V1) is set to have a negative polarity, the charging device 2 performs positive-pole electric discharge. Therefore, it is also possible to reduce ozone generation amount due to electric discharge of the charging device 2.

Furthermore, according to the embodiment, since a scorotron type charging device is used as the charging device 2, it is possible to properly control the apparent potential of the photosensitive body 1 very easily, only by setting the grid control potential.

Moreover, according to the embodiment, since output of the grid power supply 14 is variable, it is possible to change the grid control potential (the second potential V2), that is, the apparent potential in the non-exposed parts.

If the apparent potential in the non-exposed parts is changed as described above, it is possible to change the difference in potential between the second potential and the developing bias potential (the third potential V3). Therefore, it is possible to change toner adsorption amount, that is, image density.

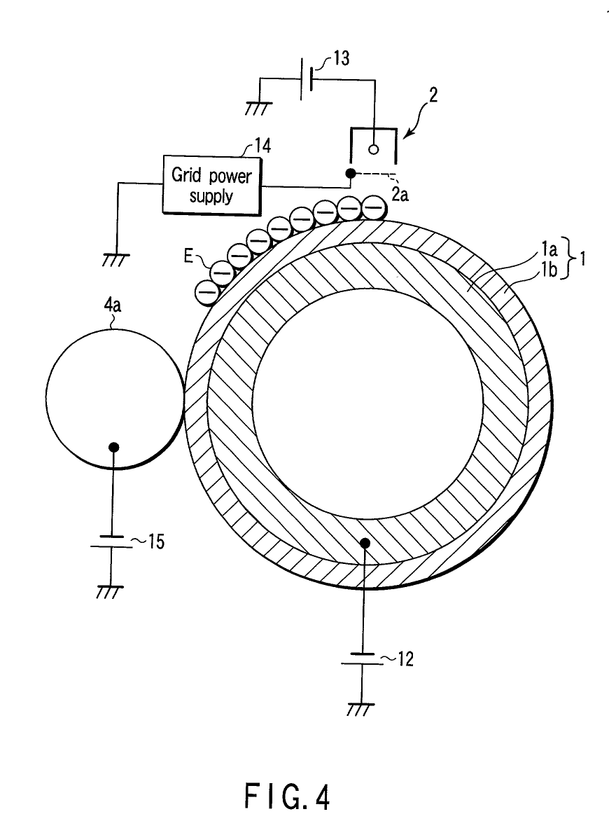

Although in the embodiment the grid control potential (the second potential V2) is 0, as shown by broken line C in FIG. 3, it may fall within a range in which the absolute value of the grid control potential is smaller than the absolute value of the developing bias potential. Further, the grid control voltage (the second potential V2) may have polarity opposite to that of the drum bias potential as shown by broken line D in FIG. 3. The present invention is not limited to the above embodiment. For example, although in the above embodiment the drum bias potential (the first potential V1) has negative polarity, it may have positive polarity as shown in FIG. 4.

Further, in the above embodiment, the drum bias power supply 12 may be +750 V, the developing bias power supply 15 may be +600 V, and the charging power supply 13 may generate a negative high voltage to be applied to the charging device 2 to cause electric discharge of the charging device 2.

In the case of adopting such a structure, the surface of the photosensitive body 1 is charged by the charging device 2 such that the apparent potential of the photosensitive body 1 conforms to the grid control potential (the second potential V2). Specifically, supposing that the grid control potential (the second potential V2) is set to 0 V, negative charge E is applied onto the surface of the photosensitive body 1 such that it balances the drum bias potential (the first potential V1) +750 V and the apparent potential of the photosensitive body 1 becomes 0 V.

In the developing device 4, toner is carried and conveyed by the developing roller 4a. At this time, positive charge is injected from the developing roller 4a to the toner and the toner is charged to have positive polarity. Then, the toner charged to have positive polarity adheres onto the surface of the photosensitive body 1.

At this time, as is clear from FIG. 5, the apparent potential in the non-exposed parts of the photosensitive body 1 is lower than the developing bias potential (the third potential V3), for the toner. Therefore, the toner is electrostatically adsorbed onto the surface of the photosensitive body 1. However, the apparent potential in the exposed parts of the photosensitive body 1 is higher than the developing bias potential (the third potential V3), for the toner. Thereby, the toner electrostatically repels the surface of the photosensitive body 1. Therefore, in the exposed parts, the toner does not adhere onto the surface of the photosensitive body 1.

As described above, the toner selectively adheres to the photosensitive body 1 only onto the non-exposed parts of the photosensitive body 1, and a desired toner image is formed on the surface of the photosensitive body 1. Further, although the grid control potential (the second potential V2) has been set to 0, it may have the same polarity as that of the drum bias potential and fall within the range in which the absolute value of the grid control potential is smaller than the absolute value of the developing bias potential, as shown by broken line F in FIG. 3. Further, the grid control voltage (the second potential V2) may have polarity opposite to that of the drum bias potential, as shown by broken line G in FIG. 3.

Specifically, the polarity and value of each potential may be any polarity and value, as long as the potentials have the relation that the drum bias potential and the developing bias potential have the same polarity, the absolute value of the developing bias potential is smaller than that of the drum bias potential, and the apparent potential of the charged photosensitive body 1 satisfies any of the following conditions:

(1) having the same polarity as that of the drum bias potential and having the absolute value smaller than that of the drum bias potential;

(2) 0; and

(3) having polarity opposite to that of the drum bias potential.

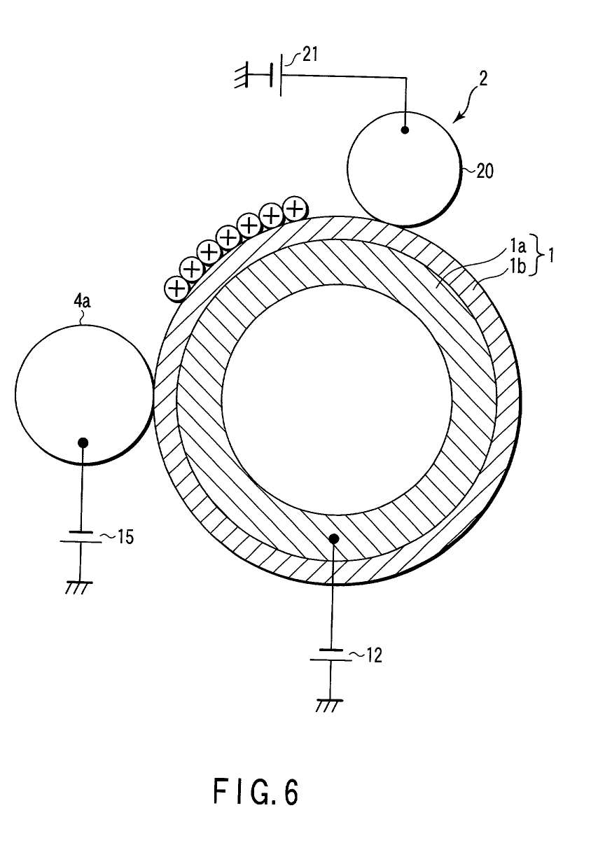

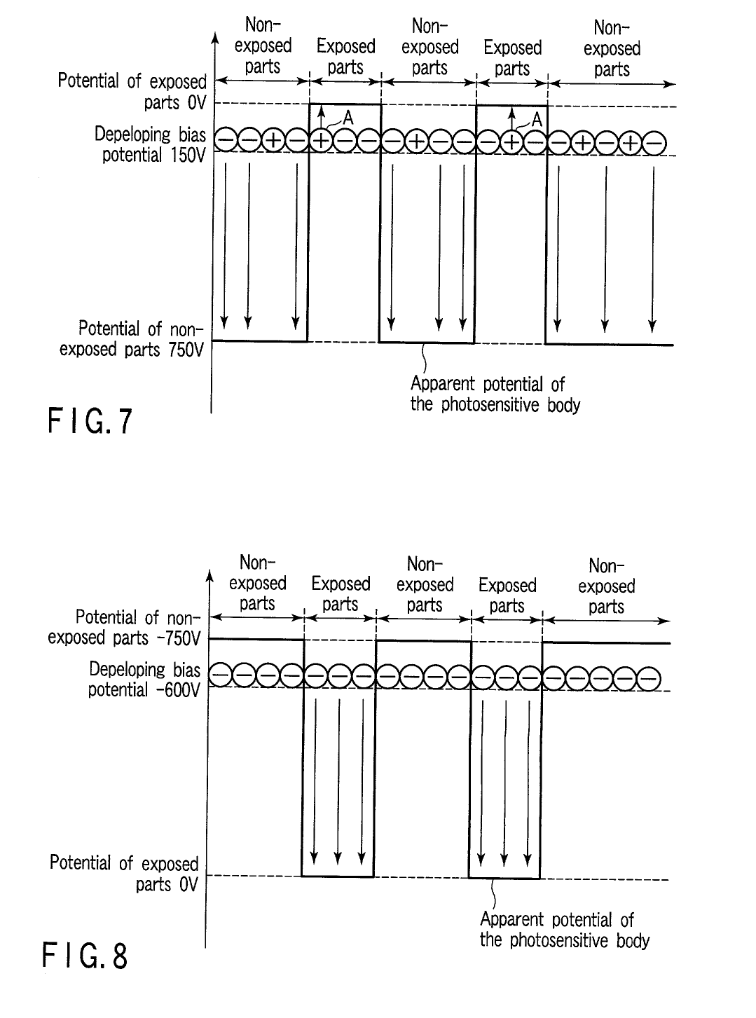

Further, in the above embodiment, although a scorotron type charging device is used as the charging device 2, a discharger of any other kind such as scorotron type may be used, or a charging device of a contact-charge system as shown in FIG. 6 may be used. Specifically, a roller 20 rotating while being in contact with the surface of the photosensitive body 1 may be provided, and a bias power supply 21 may be applied to the roller 20.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus comprising:
a photosensitive body configured to have a photosensitive layer formed on a surface of a base material made of a conductive material;
a first power supply part configured to supply a first potential V1 to the base material;
a charging part configured to charge a surface of the photosensitive body with a second potential V2 as an apparent potential of the photosensitive body;
an exposure part configured to expose areas, in which no toner image is formed, in the surface of the photosensitive body to light;
a developing part having a toner carrier which carries toner, the developing part being configured to adhere the toner carried by the toner carrier onto the surface of the photosensitive body; and
a second power supply part configured to supply a third potential V3 as a potential of the toner carrier, wherein
a relation between the potentials V1, V2 and V3 is |V2|<|V3|<|V1|.

2. An image forming apparatus according to claim 1, wherein the first potential V1 is negative.

3. An image forming apparatus according to claim 1, wherein the first potential V1 is positive.

4. An image forming apparatus according to claim 1, wherein the second potential V2 is 0 V.

5. An image forming apparatus according to claim 1, wherein a polarity of the first potential V1 is the same as a polarity of the third potential V3, and a polarity of the second potential V2 is opposite to the polarity of the first potential V1.

6. An image forming apparatus according to claim 1, wherein said toner is charged with a polarity equal to that of the first potential V1 and the second potential V2.

7. An image forming apparatus according to claim 1, wherein the charging part has a scorotron charging device.

8. An image forming apparatus comprising:
a photosensitive body configured to have a photosensitive layer formed on a surface of a base material made of a conductive material;
a first power supply part configured to supply a first potential V1 to the base material;
a charging part configured to charge a surface of the photosensitive body with a second potential V2 as an apparent potential of the photosensitive body so as to satisfy a relation |V2|<|V1| (if V1 and V2 have the same polarity);
an exposure part configured to expose toner-image non-forming areas in the surface of the photosensitive body to light;
a developing part having a toner carrier carrying toner, the developing part being configured to adhere toner carried by the toner carrier onto the surface of the photosensitive body; and
a second power supply part configured to supply a third potential V3 as a potential of the toner carrier so as to satisfy a relation |V2|<|V3|<|V1| (in the case where V1, V2 and V3 have the same polarity).

9. An image forming apparatus comprising:
a photosensitive body configured to have a photosensitive layer formed on a surface of a base material made of a conductive material;
a first power supply part configured to supply a first potential V1 to the base material;
a charging part configured to charge a surface of the photosensitive body with a second potential V2 as an apparent potential of the photosensitive body such that the second potential V2 has polarity opposite to a polarity of the first potential V1;
an exposure part configured to expose toner-image non-forming areas in the surface of the photosensitive body to light;
a developing part having a toner carrier carrying toner, the developing part being configured to adhere toner carried by the toner carrier onto the surface of the photosensitive body; and
a second power supply part configured to supply a third potential V3 as a potential of the toner carrier so as to satisfy a relation |V3|<|V1| (in the case where V1 and V3 have the same polarity).

10. An image forming method of an image forming apparatus comprising:
a photosensitive body configured to have a photosensitive layer formed on a surface of a base material made of a conductive material;
a first power supply part configured to supply a first potential V1 to the base material;
a charging part configured to charge a surface of the photosensitive body with a second potential V2 as an apparent potential of the photosensitive body;
an exposure part configured to expose areas, in which no toner image is formed, in the surface of the photosensitive body to light;
a developing part having a toner carrier carrying toner, the developing part being configured to adhere toner carried by the toner carrier onto the surface of the photosensitive body; and
a second power supply part constructed to supply a third potential V3 as a potential of the toner carrier, wherein
the potentials V1, V2 and V3 are set to have a relation |V2|<|V3|<|V1.

11. An image forming apparatus comprising:
a photosensitive body in which a photosensitive layer is formed on a surface of a base material made of a conductive material;
first power supply means for supplying a first potential V1 to the base material;
charging means for charging a surface of the photosensitive body with a second potential V2 as an apparent potential of the photosensitive body;
exposure means for exposing areas, in which no toner image is formed, in the surface of the photosensitive body to light;
developing means for having a toner carrier carrying toner, the developing means for adhering toner carried by the toner carrier onto the surface of the photosensitive body; and
second power supply means for a third potential V3 as a potential of the toner carrier, wherein
a relation between the potentials V1, V2 and V3 is |V2|<|V3|<|V1|.

12. An image forming apparatus according to claim 11, wherein
the first potential V1 is negative.

13. An image forming apparatus according to claim 11, wherein
the first potential V1 is positive.

14. An image forming apparatus according to claim 11, wherein
the second potential V2 is 0 V.

15. An image forming apparatus according to claim 11, wherein
the first potential V1 and the third potential V3 have the same polarity, and a polarity of the second potential V2 is opposite to the polarity of the first potential V1.

16. An image forming apparatus according to claim 11, wherein said toner is charged with a polarity equal to that of the first potential V1 and the second potential V2.

17. An image forming apparatus according to claim 11, wherein
the charging part has a scorotron charging device.
